(19) United States
(12) Patent Application Publication
(10) Pub. No.: US 2025/0333555 A1
(43) Pub. Date: Oct. 30, 2025

(54) COMPOSITION AND METHOD FOR PRODUCING ARTICLE

(71) Applicant: CANON KABUSHIKI KAISHA, Tokyo (JP)

(72) Inventors: RYOHEI HARADA, Kanagawa (JP); EMI OISHI, Kanagawa (JP); KENICHI KANAI, Chiba (JP); AKIRA YANE, Tokyo (JP)

(21) Appl. No.: 19/184,327

(22) Filed: Apr. 21, 2025

(30) Foreign Application Priority Data
Apr. 25, 2024 (JP) 2024-071452

(51) Int. Cl. C08F 236/22; B29C 64/124; B29K 105/00; B33Y 70/10; C08F 2/50; C08F 236/02; C08K 3/04; C08K 3/26; C08K 3/32; C08K 3/36; C08K 3/38

(52) U.S. Cl. CPC C08F 236/22; B29C 64/124; B33Y 70/10; C08F 2/50; C08F 236/02; C08K 3/04; C08K 3/36; B29K 2105/0002; C08K 2003/265; C08K 2003/323; C08K 2003/387; C08K 2201/005

(57) ABSTRACT

A photocurable composition comprises a first component composed of a photocurable compound, a second component composed of a photopolymerization initiator, a third component composed of black particles, and a fourth component composed of non-black particles. The mass concentration of the fourth component in the composition is more than 100 times the mass concentration of the third component and less than 3000 times the mass concentration of the third component.

### BACKGROUND

### Field of the Disclosure

The present disclosure relates to a photocurable composition.

### Description of the Related Art

Photocurable compositions are used in stereolithography etc. Japanese Patent Publication No. 2023-506819 (based on PCT Application No. PCT/EP2020/084655) discloses a composition that is used in additive manufacturing methods and that produces no organic volatiles during the additive manufacturing processes.

Photocurable compositions desirably have good curability (easy to cure). However, when a photocurable composition comprises a photopolymerization initiator, irradiation with an activation energy beam such as UV light decomposes the photopolymerization initiator, and volatile organic compound (VOC) components derived from the photopolymerization initiator may remain inside the cured product. Such VOCs are considered to be released from the cured product. From the viewpoint of environmental loads, decreasing such VOCs is desirable. Although the VOCs can be decreased by decreasing the photopolymerization initiator, this also degrades curability.

### SUMMARY OF THE DISCLOSURE

The present disclosure provides a technology that allows for a photocurable composition to advantageously achieve both the curability and the decrease in VOCs.

A first aspect of the present disclosure provides
a photocurable composition including:
a first component composed of a photopolymerizable compound;
a second component composed of a photopolymerization initiator;
a third component composed of black particles; and
a fourth component composed of non-black particles,
wherein:
the fourth component comprises non-black particles having a particle size of 1 μm or more and 20 μm or less, and
a mass concentration of the fourth component in the composition is more than 200 times a mass concentration of the third component and less than 3000 times the mass concentration of the third component.

A second aspect of the present disclosure provides
a photocurable composition including:
a first component composed of a photopolymerizable compound;
a second component composed of a photopolymerization initiator;
a third component composed of black particles; and
a fourth component composed of non-black particles,
wherein:
the first component comprises a cyclopolymerizable compound,
the third component comprises black particles having a pH of 4.0 or less or 9.0 or more, and
the fourth component comprises non-black particles comprising a salt.

A third aspect of the present disclosure provides
a photocurable composition including:
a first component composed of a photopolymerizable compound;
a second component composed of a photopolymerization initiator; and
a third component composed of black particles,
wherein:
the first component comprises a cyclopolymerizable compound, and
a mass concentration of the third component in the composition is 0.01 mass % or more and less than 0.10 mass %.

A fourth aspect of the present disclosure provides a method for producing an article, the method including:
a step of forming a layer of a photocurable composition; and
a step of curing the layer of the composition by irradiation with light,
wherein these steps are repeated to build a layered object, and
the composition comprises:
a first component composed of a photopolymerizable compound;
a second component composed of a photopolymerization initiator;
a third component composed of black particles; and
a fourth component composed of non-black particles,
wherein:
the third component comprises black particles having a pH of 4.0 or less or 9.0 or more, and
the fourth component comprises non-black particles comprising a salt.

A fifth aspect of the present disclosure provides a method for producing an article, the method including:
a step of forming a layer of a photocurable composition; and
a step of curing the layer of the composition by irradiation with light,
wherein these steps are repeated to build a layered object, and
the composition comprises:
a first component composed of a photopolymerizable compound;
a second component composed of a photopolymerization initiator;
a third component composed of black particles; and
a fourth component composed of non-black particles,
wherein:
a mass concentration of the third component in the composition is 0.01 mass % or more and less than 0.10 mass %, and
the fourth component comprises non-black particles comprising a flame retardant.

Further features of the present disclosure will become apparent from the following description of exemplary embodiments with reference to the attached drawings.

### BRIEF DESCRIPTION OF THE DRAWINGS

FIG. 1 is a diagram illustrating an additive manufacturing apparatus that adopts a free surface method.

FIG. 2 is a diagram illustrating an additive manufacturing apparatus that adopts a constrained surface method.

### DESCRIPTION OF THE EMBODIMENTS

Hereinafter, the embodiments for implementing the present disclosure are described with reference to the drawings. In the description below and the drawings, the same features are referenced by the same reference signs throughout multiple drawings.

Thus, the same features are described by referring to multiple drawings, and descriptions for the features referenced by the same reference signs are omitted as appropriate.

The photocurable composition according to an embodiment is hereinafter referred to as a composition X, and a product obtained by photocuring this composition X is referred to as a cured product Y. The light for curing the composition X is referred to as irradiation light. The irradiation light is typically ultraviolet light (UV) but may be visible light. The irradiation light may include light beams of multiple wavelengths including an activation energy beam and may give the composition X different effects according to the wavelength. The cured product Y is used in producing an article Z. The composition X is suitable for a method V for producing an article Z, the method involving preparing a composition X and curing the composition X by irradiating the composition X with light. The composition X is suitable for a method W for producing an article Z, the method including building (additive manufacturing) a layered object by repeating a step of forming a layer of the composition X and a step of curing the layer of the composition X by light irradiation. The article Z is either a cured product Y as is or a cured product Y subjected to a necessary process. The article Z can be used in various devices.

The composition X according to an embodiment comprises at least a component A composed of a photopolymerizable compound, a component B composed of a photopolymerization initiator, and a component C composed of black particles. The component A can be a main component of the composition X and can be a main raw material of the cured product Y. The component B accelerates polymerization of the component A. The decomposition products of the component B can comprise volatile organic compounds (VOCs). When the component A comprises a low-reactivity photopolymerizable compound, higher irradiation energy or a larger amount of the component B is necessary to polymerize this, and the amount of the VOCs generated tends to increase. Typical examples of the low-reactivity photopolymerizable compound are cyclopolymerizable compounds. During curing, the black particles constituting the component C block light, suppresses decomposition of the component B (photopolymerization initiator), and decreases the generation of the VOCs derived from the component C. Note that, in this embodiment, generation of the VOCs can be decreased as long as the irradiation light is the cause, and thus the VOCs generated by the irradiation light may be derived from components other than the component C. The composition X of this embodiment can further comprise a component D composed of non-black particles. The non-black particles constituting the component D scatter the irradiation light during light irradiation, accelerates polymerization of the component A (photopolymerizable compound) and decomposition of the component B, and thus can adjust the curability of the composition X and the amount of VOCs generated. In addition, by using the non-black particles constituting the component D, the viscosity of the composition X, the mechanical properties of the cured product Y such as strength and flame retardancy, can be controlled. Furthermore, the composition X of this embodiment may further comprise a component E that is not categorized into any of the components A to D.

In the description below, “concentration” means a mass concentration in the composition X in an amount that has a substantially homogeneous component distribution. The amount that has a substantially homogeneous component distribution can be, for example, 1 mm³ or more. That is, the mass concentrations of the components in the composition X and the substances comprised in the composition X can be determined by performing component analysis on 1 mm³ or more of the composition X.

In a first embodiment, the mass concentration of the component D in the composition X can be more than 100 times the mass concentration of the component C and less than 3000 times the mass concentration of the component C. The component C in an amount smaller than the component D can decrease the VOCs without significantly degrading the curability of the composition X.

In a second embodiment, the component C can comprise black particles having a pH of 4.0 or less or 9.0 or more. The component D can comprise non-black particles comprising a salt. Since the acidic black particles having a pH of 4.0 or less are attracted to cations of the salt comprised in the non-black particles, scattering of light by the non-black particles can be suppressed. Alternatively, since the basic black particles having a pH of 9.0 or more are attracted to anions of the salt comprised in the non-black particles, scattering of light by the non-black particles can be suppressed.

In a third embodiment, the mass concentration of the component C in the composition X can be 0.01 mass % or more and less than 0.10 mass %. A small amount of the component C can decrease the amount of generated VOCs without significantly degrading the curability of the composition X.

The first to third embodiments can be for the cases where the component A comprises a cyclopolymerizable compound. This is because, even when the irradiation energy is increased, the increase in the amount of generated VOCs can be suppressed due to inclusion of the low-reactivity photopolymerizable compound.

The first to third embodiments can be for the cases where the component D comprises non-black particles comprising a flame retardant. This is because the non-black particles that serve as a flame retardant are prone to scatter light but the component C can decrease the amount of generated VOCs.

The composition X that has features of at least one of the first to third embodiments can be used in the production methods V and W. In particular, in the production method W in which many cured product layers are stacked, the curability of each composition layer significantly affects the productivity (building rate). The amount of generated VOCs can be decreased while increasing the curability of each composition layer.

When a cyclopolymerizable compound or the like having large steric hindrance and comprised in the composition X decreases the polymerizability (reactivity), the need to add a larger amount of the photopolymerization initiator arises from the viewpoint of productivity. To address this, 0.01 mass % or more and less than 0.1 mass % of carbon black is added to the composition X, and this decreases the amount of the generated VOC component in the cured product X without excessively degrading the reactivity. When the concentration of carbon black is 0.01 mass % or more, radiated UV light or the like is absorbed by carbon black in the composition, and thus the decomposition amount of the initiator in the composition X can be reduced. When the concentration of carbon black is less than 0.1 mass %, polymerization reaction triggered by the decomposition of the photoinitiator near the irradiated surface proceeds and thus the reaction time does not excessively decrease.

The components A to E will now be specifically described.

### Component A: Photopolymerizable Compound

A photopolymerizable compound has properties to undergo polymerization reaction when attacked by a photopolymerization initiator activated by irradiation of an activation energy beam having a wavelength of a specified region. Examples of the types of the photopolymerizable compound include radical polymerizable compounds, cation polymerizable compounds, and anion polymerizable compounds. Examples of the types of the functional groups that react during polymerization include an acrylate group and a methacrylate group for radical polymerizable compounds, an epoxy group and an oxetane group for cation polymerizable compounds, and an acrylate group, a methacrylate group, a styrene group, an acrylonitrile group, an N-vinylpyrrolidone group, an acrylamide group, a conjugated diene group, and a vinyl ketone for anion polymerizable compounds. Furthermore, photopolymerizable compounds include polyfunctional compounds and monofunctional compounds.

In the component A, only one photopolymerizable compound can be used, or two or more photopolymerizable compounds can be used in combination. Furthermore, from the viewpoint of the progress of the polymerization reaction of the photopolymerizable compound, the concentration of the component A in the composition X can be in the range of 50 mass % or more and 99 mass % or less.

In preparing the composition X, the type and blend of the photopolymerizable compounds are sometimes adjusted to improve physical properties of the material, etc. In such a case, depending on the photopolymerizable compound selected, the reactivity of the photopolymerizable compound may decrease due to the type of the functional group to be polymerized and the steric structure of the compound itself.

### Cyclopolymerizable Compound

An example of the photopolymerizable compound that has low reactivity is a cyclopolymerizable compound. A cyclopolymerizable compound is a compound that forms a cyclic structure by intramolecular polymerization. The content of the cyclopolymerizable compound can be set from the viewpoints of bringing out the effect of the selected compound of improving the physical properties of the material and the like and suppressing excessive reactivity. Typically, the concentration of the cyclopolymerizable compound in the composition X can be 10 mass % or more, 20 mass % or more, 80 mass % or less, and 50 mass % or less.

Examples of the cyclopolymerizable compound include diallyl quaternary ammonium salts and 1,6-dienes such as 1,6-perfluorodiene and monofunctional 2-(allyloxymethyl) acrylic acid or esters thereof. From the viewpoints of the compatibility with other polymerizable compounds and of the polymerization reactivity, 2-(allyloxymethyl) acrylic acid or esters thereof can be used. 2-(Allyloxymethyl) acrylic acid and esters thereof are represented by general formula (1) below. The number of acryloyl groups in the cyclopolymerizable compound of general formula (1) below is 1.

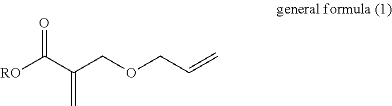

In general formula (1), R represents hydrogen or a hydrocarbon group and can be hydrogen or a hydrocarbon group having 1 or more and 4 or less carbon atoms. The hydrocarbon group is a saturated or unsaturated hydrocarbon group and may have a substituent. The hydrocarbon group may be straight-chain, branched chain, or cyclic, and may comprise an ether bond.

Examples of the hydrocarbon group include a methyl group, an ethyl group, an n-propyl group, an isopropyl group, an n-butyl group, a sec-butyl group, a tert-butyl group, a vinyl group, an allyl group, a methallyl group, a crotyl group, a cyclopropyl group, a cyclobutyl group, a methoxymethyl group, a methoxyethyl group, an ethoxymethyl group, an ethoxyethyl group, a vinyloxyethyl group, an epoxy group, and an oxetanyl group. The hydrocarbon group can be a hydrocarbon group having 1 or more and 2 or less carbon atoms.

Examples of the substituent that the hydrocarbon group may have include chain unsaturated hydrocarbon groups such as a vinyl group, an allyl group, a methallyl group, and a crotyl group; cyclic ether structures such as an epoxy group, a glycidyl group, and an oxetanyl group; alkoxy groups such as a methoxy group, an ethoxy groups, and a methoxyethoxy group; alkylthio groups such as a methylthio group and an ethylthio group; acyl groups such as an acetyl group and a propionyl group; acyloxy groups such as an acetyloxy group and a propionyloxy group; alkoxycarbonyl groups such as a methoxycarbonyl group and an ethoxycarbonyl group; alkylthiocarbonyl groups such as a methylthiocarbonyl group and an ethylthiocarbonyl group; halogen atoms such as a fluorine atom, a chlorine atom, a bromine atom, and an iodine atom; an ureide group; an amide group; a cyano group; a hydroxyl group; and a trimethylsilyl group.

Commercially available products can also be used as the cyclopolymerizable compound, and an example thereof is AOMA (produced by NIPPON SHOKUBAI CO., LTD.). AOMA has a structure represented by general formula (1) where R represents a methyl group.

### Monofunctional Radical Polymerizable Compound

Examples of the monofunctional radical polymerizable compound include, but are not limited to, the following monofunctional (meth)acrylates: 4-tert-butylcyclohexanol (meth)acrylate, 3,3,5-trimethylcyclohexanol (meth)acrylate, isobornyl (meth)acrylate, cyclic trimethylolpropane formal (meth)acrylate, 3-hydroxy-1-(meth)acryloyloxyadamantane, 1-adamantyl (meth)acrylate, 2-methyl-2-adamantyl (meth)acrylate, dicyclopentaenyl (meth)acrylate, 2-isopropyladamantan-2-yl (meth)acrylate, tetrahydrodicyclopentadienyl (meth)acrylate, α-(meth)acryloxy-γ-butyrolactone, 2-hydroxy-o-phenylphenolpropyl (meth)acrylate, acryloylmorpholine, diethylacrylamide, isopropylacrylamide, hydroxyethylacrylamide, cyclohexyl (meth)acrylate, methyl (meth)acrylate, 2-ethylhexyl (meth)acrylate, lauryl (meth)acrylate, stearyl (meth)acrylate, isooctyl (meth)acrylate, tetrahydrofurfuryl (meth)acrylate, isobornyl (meth)acrylate, benzyl (meth)acrylate, phenoxyethyl (meth)acrylate, phenoxypolyethylene glycol (meth)acrylate, phenylglycidyl (meth)acrylate, lauryl (meth)acrylate, isodecyl (meth)acrylate, stearyl (meth)acrylate, isooctyl (meth)acrylate, tridecyl (meth)acrylate, ethoxydiethylene glycol (meth)acrylate, methoxyditripropylene glycol (meth)acrylate, tricyclodecane (meth)acrylate, dicyclopentadieneoxyethyl (meth)acrylate, dicyclopentenyl acrylate, dicyclopentenyloxyethyl acrylate, dicyclopentenyloxy methacrylate, dicyclopentanyl acrylate, and dicyclopentanyl methacrylate.

### Polyfunctional Radical Polymerizable Compound

Examples of the polyfunctional radical polymerizable compound include (meth)acrylate compounds, vinyl ether group-comprising (meth)acrylate compounds, (meth)acryloyl group-comprising isocyanurate compounds, (meth)acrylamide compounds, urethane (meth)acrylate compounds, maleimide compounds, vinyl ether compounds, and aromatic vinyl compounds. Among these, from the viewpoints of availability and curability, (meth)acrylate compounds and urethane (meth)acrylate compounds may be used.

### Cation Polymerizable Compound

Examples of the cation polymerizable compound include, but are not limited to, hydrogenated bisphenol A diglycidyl ether, hydrogenated bisphenol F diglycidyl ether, hydrogenated bisphenol AD diglycidyl ether, hydrogenated bisphenol Z diglycidyl ether, cyclohexane dimethanol diglycidyl ether, tricyclodecane dimethanol diglycidyl ether, 3,4-epoxycyclohexylmethyl-3′,4′-epoxycyclohexane carboxylate, 3,4-epoxy-1-methylcyclohexyl-3,4-epoxy-1-methylcyclohexane carboxylate, 6-methyl-3,4-epoxycyclohexylmethyl-6-methyl-3,4-epoxycyclohexane carboxylate, 3,4-epoxy-3-methylcyclohexylmethyl-3,4-epoxy-3-methylcyclohexane carboxylate, 3,4-epoxy-5-methylcyclohexylmethyl-3,4-epoxy-5-methylcyclohexanecarboxylate, 2-(3,4-epoxycyclohexyl-5,5-spiro-3,4-epoxy)cyclohexane-metadioxane, bis(3,4-epoxycyclohexylmethyl) adipate, 3,4-epoxy-6-methylcyclohexylcarboxylate, dicyclopentadiene diepoxide, ethylene bis(3,4-epoxycyclohexanecarboxylate), dioctyl epoxyhexahydrophthalate, di-2-ethylhexyl epoxyhexahydrophthalate, ε-caprolactone-modified 3′,4′-epoxycyclohexylmethyl-3,4-epoxycyclohexanecarboxylate, 1,2-epoxy-4-(2-oxiranyl)cyclohexane adduct of 2,2-bis(hydroxymethyl)-1-butanol, bis(3,4-epoxycyclohexyl) methane, 2,2-bis(3,4-epoxycyclohexyl) propane, 1,1-bis(3,4-epoxycyclohexyl) ethane, alpha-pinene oxide, campholenaldehyde, limonene monoxide, limonene dioxide, 4-vinylcyclohexene monoxide, 4-vinylcyclohexene dioxide, 3-hydroxymethyl-3-methyloxetane, 3-hydroxymethyl-3-ethyloxetane, 3-hydroxymethyl-3-propyloxetane, 3-hydroxymethyl-3-n-butyloxetane, and 3-hydroxymethyl-3-propyloxetane.

### Anion Polymerizable Compound

Examples of the anion polymerizable compound include, but are not limited to, epoxy compounds, lactone compounds, acrylic compounds, and methacrylic compounds.

### Component B: Photopolymerization Initiator

The photopolymerization initiator can be selected as appropriate for the curing conditions (irradiation wavelength and dosage) for the curable resin. Radical photoinitiators, cationic photoinitiators, and anionic photoinitiators are available as the types of the photopolymerization initiators.

A material that decomposes under activation energy beam irradiation to generate radicals and thereby causes a photopolymerizable resin to cure is used as a radical photoinitiator. From the economical viewpoint, ultraviolet radiation having a wavelength of 300 nm to 450 nm can be used as the activation energy beam, and a photopolymerization initiator that generates radicals under irradiation with an activation energy beam of such a wavelength can be used.

A photopolymerization initiator decomposes under irradiation with an activation energy beam such as UV light, and VOCs derived from the initiator may remain inside the photocured product. Such VOCs are considered to be released from the stereolithographically built objects. Under the recent trends of environmental consciousness, decreasing such VOCs is desirable. Particularly when the component D comprises a compound intramolecularly having trimethylbenzene, decreasing VOCs derived from such a compound is important.

The mass concentration of the component B in the composition X can be, for example, 0.1 mass % or more and 0.5 mass % or more; and in order to accelerate the reaction of the component A when the component A has low reactivity, the mass concentration of the component B can be 1 mass % or more. The mass concentration of the component B in the composition X is, for example, 10 mass % or less, and from the viewpoint of decreasing the VOCs, the mass concentration of the component B can be 5 mass % or less.

A photopolymerization initiator that generates radicals by an activation energy beam of such a wavelength can have an aromatic ring. Examples thereof include, but are not limited to, bis(2,4,6-trimethylbenzoyl)-phenylphosphine oxide, 2,4,6-trimethylbenzoyl-diphenylphosphine oxide, 2-benzyl-2-dimethylamino-1-(4-morpholinophenyl)-1-butanone, 1-hydroxycyclohexyl phenyl ketone, 2-hydroxy-2-methyl-1-phenyl-propan-1-one, 4-phenylbenzophenone, 4-phenoxybenzophenone, 4,4′-diphenylbenzophenone, and 4,4′-diphenoxybenzophenone.

Among these, an acylphosphine oxide compound, representative examples of which include bis(2,4,6-trimethylbenzoyl)-phenylphosphine oxide and 2,4,6-trimethylbenzoyl-diphenylphosphine oxide, may be comprised. A photopolymerization initiator that is an acylphosphine oxide compound has high photopolymerization initiating activity and a photobleaching effect. A photobleaching effect is a phenomenon in which, once the photopolymerization initiator becomes decomposed by absorbing light, the decomposed photopolymerization initiator residue no longer absorbs ultraviolet radiation and is no longer capable of preventing ultraviolet radiation from penetrating inside. Thus, an acylphosphine oxide compound has excellent internal curability and is capable of curing a thick film.

Only one photopolymerization initiator can be used, or two or more photopolymerization initiators can be used in combination.

The concentration of the photopolymerization initiator is adjusted as appropriate for the type of the polymerizable compound used, and can be in the range of 0.01 parts by mass or more and 10 parts by mass or less per 100 parts by mass of the polymerizable compound. When the concentration of the photopolymerization initiator is excessively low, curing does not occur even when the light irradiation intensity or irradiation time is increased. In contrast, when the concentration of the initiator is excessively high, there are risks that the average molecular weight may decrease, for example.

In addition, the reactivity may decrease depending on the steric structure and the type of functional group of the polymerizable compound to be used. An example of this is when monofunctional 2-(allyloxymethyl) acrylic acid or an ester thereof is used. In such a case, the concentration of the photopolymerization initiator can be in the range of 2.00 parts by mass or more and 10.00 parts by mass or less per 100 parts by mass of the polymerizable compound although this depends on the blend amount of this polymerizable compound. Furthermore, the concentration of the photopolymerization initiator needs to be adjusted according to the transmittance of the material for the polymerizable compound also. In particular, when a material that absorbs irradiation light is comprised in the composition X, the concentration of the photopolymerization initiator needs to be increased to improve curability. Note that the ratio of the photopolymerization initiator added may be selected as appropriate for the dosage of the activation energy beam and the additional heating temperature.

Furthermore, the ratio may be adjusted according to the targeted average molecular weight of the polymer to be obtained.

When a cation polymerizable compound is added, a polymerization initiator that generates cationic species under light irradiation, a photoacid generator, and/or a photobase generator may be added to the composition X to accelerate the polymerization reaction of the cation polymerizable compound. Examples of the polymerization initiator that generates cationic species under light irradiation include, but are not limited to, iodonium (4-methylphenyl) [4-(2-methylpropyl)phenyl]-hexafluorophosphate. Examples of the photoacid generator include, but are not limited to, triarylsulfonium hexafluoroantimonate, triphenylphenacylphosphonium tetrafluoroborate, triphenylsulfonium hexafluoroantimonate, bis-[4-(diphenylsulfonio)phenyl]sulfide bisdihexafluoroantimonate, bis-[4-(di-4′-hydroxyethoxyphenylsulfonio)phenyl]sulfide bisdihexafluoroantimonate, bis-[4-(diphenylsulfonio)phenyl]sulfide bisdihexafluorophosphate, and diphenyliodonium tetrafluoroborate.

When an anion polymerizable compound is added, a polymerization initiator that generates anionic species under light irradiation, a photoacid generator, and/or a photobase generator may be added to the composition X to accelerate the polymerization reaction of the anion polymerizable compound. Examples of the polymerization initiator that generated anionic species include o-nitrobenzyl carbamate derivatives, o-acyloxyl derivatives, and o-carbamoyloxime amidine derivatives.

The concentration of the polymerization initiator that generates cationic species can be in the range of 0.01 parts by mass or more and 10.00 parts by mass or less per 100 parts by mass of the cation polymerizable compound. The concentration of the polymerization initiator that generates anionic species can be in the range of 0.01 parts by mass or more and 10.00 parts by mass or less per 100 parts by mass of the anion polymerizable compound.

### Component C: Black Particles

The black particles act as a light absorber, and has an effect of decreasing the decomposition amount of the initiator by decreasing the light entering the inside of the composition X or the cured product Y that lies under the composition X in additive manufacturing. Various black pigments can be used as the black particles, and examples thereof include carbon black pigments such as carbon black and graphite and metal compound black pigments such as titanium black and iron black. One type of black particles may be used alone or two or more types black particles may be used in combination. For example, black particles having a pH of 4.0 or less and black particles having a pH of more than 4 and less than 9 may be used in combination, or carbon black and titanium black may be used in combination.

From the viewpoint of the effect of decreasing the amount of generated VOCs, the concentration of the component C in the composition X can be 0.01 mass % or more. The concentration of the component C in the composition X can be 10 mass % or less, for example, 5 mass % or less; however, from the viewpoint of the curability, the concentration may be less than 1.00 mass %, can be less than 0.50 mass %, or can be less than 0.10 mass %.

The particle size of the black particles is, for example, 1 nm or more and can be 10 nm or more. The particle size of the black particles can be, for example, less than 10 μm, less than 1 μm, less than 500 nm, and less than 100 nm. When the particle size of the black particles is 10 μm or more, the specific surface area of the black particles is small and the irradiation light attenuating effect and the VOC decreasing effect may not be sufficient; moreover, the rear side of the black particles to the irradiation light becomes insufficiently cured, and thus it becomes difficult to properly cure the composition X. Of the black particles comprised in the component C, those black particles that have the aforementioned particle size contribute to improving the composition X, the cured product Y, and the production methods V and W. The component C may comprise black particles that have a particle size outside the aforementioned range. The average particle size of the black particles comprised in the component C can be the aforementioned particle size.

When the component D (non-black particles) is added to the composition X, the types of the non-black particles and the black particles are appropriately combined to decrease the amount of the VOCs generated without excessively degrading the reactivity. Specifically, a salt composed of an anion and a cation is used as a material comprised in the non-black particles, and black particles having a pH of 4.0 or less or 9.0 or more are used as the black particles. According to this combination, the black particles gather on the surfaces of the non-black particles, reduce the scattering of the irradiation light by the non-black particles, and suppress decomposition of the component B, and thus the amount of the VOCs generated can be decreased. An example of the black particles having a pH of 4.0 or less or 9.0 or more is carbon black.

For example, a coulomb interaction can occur between a positively charged portion derived from the cation of the salt in the non-black particles and a negatively charged portion derived from a surface acidic group, such as a carboxy group or a hydroxy group, of carbon black having a pH of 4.0 or less. Alternatively, a coulomb interaction can occur between a negatively charged portion derived from the anion of the salt in the non-black particles and a positively charged portion derived from a chromene or pyrone structure of carbon black having a pH of 9.0 or more. By utilizing these coulomb interactions, carbon black gathers on the surfaces of the non-black particles.

As a result, the black particles around the non-black particles absorb irradiation light and thereby decrease the amount of the scattered light from the non-black particles, and thus the amount of the VOCs generated can be decreased.

Examples of the commercially available carbon black are as follows:
products of Mitsubishi Chemical Corporation: MA7, MA8, MA11, MA14, MA77, MA100, MA100R, MA100S, MA220, MA230, MA600, MCF88, #5, #10, #20, #25, #30, #32, #33, #40, #44, #45, #47, #50, #52, #55, #650, #750, #850, #900, #950, #960, #970, #980, #990, #1000, #2200, #2300, #2350, #2400, #2600, #2650, #3030, #3050, #3150, #3250, #3400, #3600, #3750, #3950, #4000, #4010, OIL7B, OIL9B, OIL11B, OIL30B, and OIL31B;
products of Degussa AG: Printex (registered trademark, the same applies hereinafter) 3, Printex 3OP, Printex 30, Printex 30OP, Printex 40, Printex 45, Printex 55, Printex 60, Printex 75, Printex 80, Printex 85, Printex 90, Printex A, Printex L, Printex G, Printex P, Printex U, Printex V, Special Black 550, Special Black 350, Special Black 250, Special Black 100, Special Black 6, Special Black 5, Special Black 4, Color Black FW1, Color Black FW2, Color Black FW2V, Color Black FW18, Color Black FW200, Color Black S160, and Color Black S170;
products of Cabot Corporation: Monarch (registered trade mark, the same applies hereinafter) 120, Monarch 280, Monarch 460, Monarch 800, Monarch 880, Monarch 900, Monarch 1000, Monarch 1100, Monarch 1300, Monarch 1400, Monarch 4630, REGAL (registered trade mark, the same applies hereinafter) 99, REGAL 99R, REGAL 415, REGAL 415R, REGAL 250, REGAL 250R, REGAL 330, REGAL 400R, REGAL 55R0, REGAL 660R, BLACK PEARLS 480, PEARLS 130, VULCAN (registered trade mark, the same applies hereinafter) XC72R, and ELFTEX (registered trade mark)-8; and products of Columbian Carbon Company: RAVEN (registered trade mark, the same applies hereinafter) 11, RAVEN 14, RAVEN 15, RAVEN 16, RAVEN 22, RAVEN 30, RAVEN 35, RAVEN 40, RAVEN 410, RAVEN 420, RAVEN 450, RAVEN 500, RAVEN 780, RAVEN 850, RAVEN 890H, RAVEN 1000, RAVEN 1020, RAVEN 1040, RAVEN 1060U, RAVEN 1080U, RAVEN 1170, RAVEN 1190U, RAVEN 1250, RAVEN 1500, RAVEN 2000, RAVEN 2500U, RAVEN 3500, RAVEN 5000, RAVEN 5250, RAVEN 5750, and RAVEN 7000.

Examples of commercially available carbon black having a pH of 4.0 or less are as follows:
products of Mitsubishi Chemical Corporation: MA7, MA8, MA11, MA14, MA77, MA100, MA100R, MA100S, MA220, MA230, #970, #1000, #2350, and #2650;
products of Degussa AG: Special Black 550, Special Black 350, Special Black 250, Special Black 100, Special Black 6, Special Black 5, and Special Black 4;
products of Cabot Corporation: Black Pearls and MONARCH 1300; and
products of Columbian Carbon Company: RAVEN 14, RAVEN 1040, RAVEN 1060U, RAVEN 1080U, and RAVEN 3500.

Examples of commercially available carbon black having a pH of 9.0 or more are as follows:
products of Orion Engineered Carbons S.A.: PRINTEX 3, PRINTEX 25, PRINTEX 30, PRINTEX 35, PRINTEX 45, PRINTEX 55, PRINTEX 60, PRINTEX 75, PRINTEX 80, PRINTEX 85, PRINTEX 90, PRINTEX 95, PRINTEX 200, PRINTEX 300, PRINTEX A, PRINTEX F80, PRINTEX F85, PRINTEX FP, PRINTEX G, PRINTEX L, PRINTEX L6, PRINTEX P, PRINTEX 20L and PRINTEX30L.

### Component D: Non-Black Particles

The non-black particles constituting the component D are particles having lower light absorption for the irradiation light than the black particles of the component C, are typically white particles or colorless particles, and may be color particles.

The non-black particles function as a light-scattering body and scatter the irradiation light entering inside the composition X, and thus can serve as a factor that affects the curability; however, the non-black particles can also serve as a factor that increases the decomposition amount of the initiator. For example, the irradiation light scattered by the non-black particles imparts energy to unintended regions of the composition X. Thus, an issue arises in that the amount of the VOCs generated increases depending on the type, shape, and amount of the non-black particles. Here, scattering of the irradiation light by the non-black particles is typically diffuse reflection and diffractive scattering by the non-black particles; alternatively, the scattering may be caused by the difference in refraction between the non-black particles and the matrix material therearound. Thus, the non-black particles may be transparent with respect to the irradiation light.

When the travel direction of the irradiation light becomes uneven by the forward scattering (diffractive scattering) and backscattering (diffuse reflection) of the irradiation light, excessive energy may be applied to a site where the irradiation light beams intersect. Moreover, when the irradiation light that has passed through the matrix material (components A and B) of the composition X is back-scattered by the non-black particles, the irradiation light illuminates the matrix again and thus the composition X is exposed to double energy. Such a phenomenon sometimes enhances the curability of the composition X but can increase the amount of the generated VOCs since the VOC source such as the component B becomes decomposed. There may be cases where the irradiation light that has passed through the matrix material (components A and B) of the composition X is side-scattered by the non-black particles. When side scattering occurs near the boundary between a build region and a non-build region in stereolithography, curing may proceed in the non-build region and the building accuracy may be affected.

The non-black particles function as a flame retardant that imparts flame retardancy to the cured product composed of the photopolymerizable compound or as a filler for adjusting mechanical properties. When an article Z, which is a layered object such as the one produced by the production method W, is to be produced, the article Z is often required to have flame retardancy. When the component D comprises non-black particles comprising a flame retardant, the flame retardancy of the cured product Y and the article Z can be enhanced. Note that when the composition X comprises black particles for imparting flame retardancy or high mechanical strength, these black particles are treated as a component C.

The non-black particles may serve as a color adjustor or a colorant for adjusting the colors of the composition X and the cured product Y. In order for the non-black particles to serve as a color adjustor or a colorant, the concentration of the component C can be less than 0.1 mass %. When the concentration of the component C exceeds 0.1 mass %, the composition X and the cured product Y become almost completely black, and color adjustment becomes difficult.

The concentration of the component D in the composition X can be 50 mass % or less, for example, 40 mass % or less, 30 mass % or less, and 25 mass % or less.

The composition X may be free of a component D, or the concentration of the component D may be 0.01 mass % or more. The concentration of the component D can be, for example, 1.00 mass % or more, 5 mass % or more, 10 mass % or more, and 15 mass % or more.

The concentration of the component D in the composition X can be more than 100 times the concentration of the component C in the composition X (D/C>100) and can be more than 200 times the concentration of the component C (D/C>200). In other words, the concentration of the component C in the composition X can be less than 1/100 of the concentration of the component D in the composition X and can be less than 1/200 of the concentration of the component D. The effect of decreasing the VOCs by the component C can be obtained even when the amount of the component C is small compared with the component D, and, in order to ensure curability, the amount of the component C may be small compared to the component D. When the concentration of the component C is 0.01 mass %, the relationship D/C>100 is satisfied as long as the concentration of the component D is larger than 1.00 mass %. When the concentration of the component C is less than 0.10 mass %, the relationship D/C>100 is satisfied as long as the concentration of the component D is 10 mass % or more.

The concentration of the component D in the composition X can be less than 3000 times the concentration of the component C in the composition X (D/C>3000) and can be less than 2000 times the concentration of the component C (D/C>2000). In other words, the concentration of the component C in the composition X can be more than 1/3000 of the concentration of the component D in the composition X and can be more than 1/2000 of the concentration of the component D. Since the amount of the VOCs may increase with the increase in the amount of the component D, the component C can be increased according to the increase in the amount of the component D. When the concentration of the component C is 0.01 mass % or more, the relationship D/C>3000 is satisfied as long as the concentration of the component D is less than 30 mass %.

The particle size of the non-black particles can be, for example, 10 nm or more, 500 nm or more, and 1 μm or more. The particle size of the non-black particles can be, for example, 100 μm or less, 50 μm or less, and 20 μm or less. When the particle size of the non-black particles is excessively small, the dispersibility of the non-black particles can be degraded. Note that when the particle size of the non-black particles is excessively large, it becomes difficult to properly cure the composition X. Of the non-black particles comprised in the component D, those non-black particles that have the aforementioned particle size contribute to improving the composition X, the cured product Y, and the production methods V and W. The component D may comprise non-black particles that have a particle size outside the aforementioned range. The average particle size of the non-black particles comprised in the component D can be the aforementioned particle size.

The component C can comprise black particles having a small particle size. The component D can comprise non-black particles having a large particle size. Here, the large particle size is larger than the small particle size, but the large particle size can be 10 times the small particle size or more, 100 times the small particle size or more, 2000 times the small particle size or less, and may be 1000 times the small particle size or less. The particle size of the black particles having a small particle size comprised in the component C can be 10 to 100 nm. The particle size of the non-black particles having a large particle size comprised in the component D can be 1 to 20 μm.

Examples of the substance comprised in the non-black particles include salts, oxides, resins, rubbers, inorganic fibers, and organic fibers.

A salt has an anion and a cation and is a compound in which an anion and a cation are ionically bonded. The salt may be a normal salt, an acidic salt, or a basic salt. The salt may be an inorganic salt or an organic salt.

A salt composed of an anion and a cation is selected as the non-black particles and is used in combination with acidic or basic black particles. In this manner, a coulomb interaction is induced between a portion derived from the cation on the surfaces of the non-black particles and a negatively charged portion derived from a surface acidic group, such as a carboxy group or a hydroxy group, on the surfaces of the black particles. In other cases, a coulomb interaction is induced between a portion derived from the anion on the surfaces of the non-black particles and a positively charged portion derived from a chromene or pyrone structure on the surfaces of the black particles. As a result, the black particles gather on the surfaces of the non-black particles and suppress light scattering. At the same time, direct irradiation light other than the scattered light is absorbed by the black particles. As a result, the initiator near the light irradiated surface is selectively decomposed, and the amount of the VOCs generated is decreased.

The anion may be a monoatomic ion such as a chlorine ion or a polyatomic ion such as oxoanion. The salt may have an oxoanion. A salt having an oxoanion can be referred to as an oxoacid salt. Examples of the oxoacid salt include phosphates, borates, silicates, carbonates, sulfates, and stannates.

The salt may have a polyoxoanion. A polyoxoanion has an oxoanion polymer as a skeleton. The structure of the polymer is either chain or ring. The salt has a cation bonded to the polymer of the oxoanion and is represented by general formula (2) below. In general formula (2), oxo-represents an oxoanion and cat+ represents a cation.

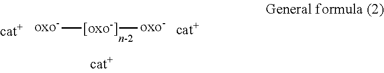

A salt having a polyoxoanion can be referred to as a polyoxoacid salt. Examples of the polyoxoacid salt include polysilicates, polyborates, polyphosphates, and polystannates. A polyphosphate is a phosphate that comprises a polymerization mode in which adjacent phosphorus atoms are bonded with other phosphorus atoms via oxygen atoms, and is one type of a polyoxoacid salt. Examples of the polyphosphate include ammonium polyphosphate, aluminum polyphosphate, melamine polyphosphate, and piperazine polyphosphate.

The cation may be a monoatomic ion such as a metal ion or a polyatomic ion such as an ammonium ion. When the cation of the salt is a metal ion, the salt is a metal salt, and when the anion of the salt is an ammonium ion, the salt is an ammonium salt.

Examples of the salt include ammonium phosphate, sodium borate, calcium silicate, aluminum silicate, clay, diatomaceous earth, calcium carbonate, magnesium carbonate, calcium sulfate, and barium sulfate.

The polyoxoacid salt forms a structure in which there are abundant cations on the surfaces of the non-black particles as the cations add to the outer side of the chain or ring polymer. Thus, a stronger interaction with the black particles having a pH of 4.0 or less is induced. Accordingly, when the component D comprises non-black particles comprising a polyoxoacid salt, the component C can comprise black particles having a pH of 4.0 or less.

The non-black particles can comprise ammonium polyphosphate. Ammonium polyphosphate is an ammonium salt of a phosphoric acid polymer represented by general formula (3) below. Ammonium polyphosphate is a halogen-free flame retardant and is used to impart flame retardancy to the cured product Y. The polymerization molecular weight is about 800 to 200,000 but is not particularly limited. The crystal structures of ammonium polyphosphate are type I, type II, type III, type IV, and type V, but any type can be used.

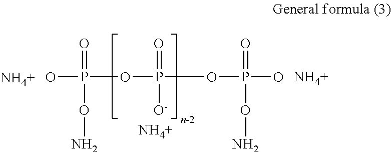

From the viewpoint of the dispersion stability in the composition X in an uncured state, the number-average particle size of the flame retardant can be, for example, 10 nm or more, 500 nm or more, and 1 μm or more. The number-average particle size of the flame retardant can be, for example, 100 μm or less, 50 μm or less, and 20 μm or less. The number-average particle size can be measured by using a laser diffraction particle size distribution meter if the flame retardant can be extracted. In a state where the flame retardant is comprised in the cured product, the particle size is measured for particles in a SEM image of a cross section and the average thereof can be calculated. The flame retardant can be used irrespective of whether the surface treatment has been conducted, but a flame retardant not subjected to a surface treatment may be used.

The concentration of the flame retardant in the composition X can be, for example, 5 mass % or more, 10 mass % or more, and 15 mass % or more, and can be, for example, 40 mass % or less, 30 mass % or less, and 25 mass % or less. When the concentration of the flame retardant is low, the flame retardancy may be degraded, and when the concentration of the flame retardant is high, the impact resistance may be degraded.

Examples of the oxide comprised in the non-black particles include, but are not limited to, silicon oxide (silica), titanium oxide (titania), and aluminum oxide (alumina). Examples of the resin comprised in the non-black particles include, but are not limited to, acryl, polystyrene, and nylon. Examples of the rubber comprised in the non-black particles include, but are not limited to, butadiene rubber, styrene-butadiene rubber copolymer, acrylonitrile-butadiene copolymer rubber, and saturated rubber obtained by hydrogenating or partially hydrogenating these diene rubbers, crosslinked butadiene rubber, isoprene rubber, chloroprene rubber, natural rubber, silicone rubber, ethylene/propylene/diene monomer terpolymer rubber, acrylic rubber, and acrylic/silicone composite rubber. Examples of the organic fibers comprised in the component D include, but are not limited to, nylon fibers and cellulose nanofibers.

Non-black particles that comprise silica, alumina, and calcium carbonate can be used as fillers. Fibers can also be used as fillers. Phosphorus compounds and boron compounds can be used as flame retardants. Non-black particles that comprise rubber can be used as elastomers. Titania can be used as a white pigment.

Component E: Component Other than Components A to D

As long as extensive performance degradation of the cured product does not occur, a solvent, a polymerization inhibitor, a photosensitizer, a light stabilizer, a thermal stabilizer, an oxidation inhibitor, a chain transfer agent, a curing aid, etc., can be added to the composition X of the present embodiment.

The concentration of the polymerization inhibitor in the composition X can be in the range of 0.01 mass % or more and 1.00 mass % or less. Moreover, only one polymerization inhibitor may be used alone or two or more polymerization inhibitors may be used in combination. In view of reducing the coloring, specifically, hydroquinone polymerization inhibitors can be used in combination. Examples of the polymerization inhibitor include hydroquinone polymerization inhibitors such as hydroquinone, hydroquinone monomethyl ether, hydroquinone monoethyl ether, hydroquinone monopropyl ether, hydroquinone monobutyl ether, hydroquinone monopentyl ether, hydroquinone monohexyl ether, hydroquinone monooctyl ether, and hydroquinone monoheptyl ether, and phenolic polymerization inhibitors that have substituents, such as 3-(3,5-di-tert-butyl-4-hydroxyphenyl) propionate. However, since hydroquinone polymerization inhibitors such as hydroquinone and benzoquinone polymerization inhibitors such as benzoquinone may undergo yellowing by UV irradiation, such inhibitors can be used in forming thin-film cured products such as coatings. Examples of the polymerization inhibitor serving as the polymerization suppressor during reaction or storage include, but are not limited to, those described above.

The concentration of the photosensitizer in the composition X can be in the range of 0.01 mass % or more and 10.00 mass % or less. Examples of the photosensitizer include benzophenone, 4,4-diethylaminobenzophenone, 1-hydroxycyclohexyl phenyl ketone, isoamyl p-(dimethylamino)benzoate, methyl 4-(dimethylamino)benzoate, benzoin, benzoin ethyl ether, benzoin isobutyl ether, benzoin isopropyl ether, 2,2-diethoxyacetophenone, methyl o-benzoylbenzoate, 2-hydroxy-2-methyl-1-phenylpropan-1-one, and acylphosphine oxide.

In some cases, the light stabilizer acts as a photosensitizer, and, in such cases, the photosensitizer does not have to be added. The concentration of the light stabilizer in the composition X can be in the range of 0.01 mass % or more and 10.00 mass % or less. The light stabilizer may be any compound that does not extensively affect the properties of the cured product, and examples thereof include benzotriazole compounds such as 2-(2H-benzotriazol-2-yl)-p-cresol, 2-(2H-benzotriazol-2-yl)-4,6-bis(1-methyl-1-phenylethyl) phenol, 2-[5-chloro(2H)-benzotriazol-2-yl]-4-methyl-6-(tert-butyl) phenol, 2-(2H-benzotriazol-2-yl)-4,6-di-tert-pentylphenol, 2-(2H-benzotriazol-2-yl)-4-(1,1,3,3-tetramethylbutyl) phenol, 2,2′-methylenebis[6-(2H-benzotriazol-2-yl)]-4-(1,1,3,3-tetramethylbutyl) phenol, and 2-(2H-benzotriazol-2-yl)-6-dodecyl-4-methylphenol, cyano acrylate compounds such as ethyl 2-cyano-3,3-diphenylacrylate and 2-ethylhexyl 2-cyano-3,3-diphenylacrylate, triazine compounds, and benzophenone compounds such as octabenzone and 2,2′-4,4′-tetrahydrobenzophenone.

The concentration of the thermal stabilizer in the composition X can be in the range of 0.01 mass % or more and 10.00 mass % or less. The thermal stabilizer may be any compound that does not extensively affect the properties of the cured product, and examples thereof include pentaerythritol tetrakis[3-(3,5-di-tert-butyl-4-hydroxyphenyl)]propionate, octadecyl-3-(3,5-di-tert-butyl-4-hydroxyphenyl) propionate, C7-C9 alkyl esters having 3,5-bis(1,1-dimethylethyl)-4-hydroxybenzenepropanoic acid side chains, hindered phenol compounds such as 4,6-bis(octylthiomethyl)-o-cresol, 4,6-bis(dodecylthiomethyl)-o-cresol, ethylene bis(oxyethylene)bis[3-(5-tert-butyl-4-hydroxy-m-tolyl)]propionate, and hexamethylene bis[3-(3,5-di-tert-butyl-4-hydroxyphenyl)]propionate, phosphorus compounds such as tris(2,4-di-tert-butylphenyl) phosphite, and sulfur compounds such as dioctadecyl-3,3′-thiopropionate.

The concentration of the oxidation inhibitor in the composition X can be in the range of 0.01 mass % or more and 10.00 mass % or less. The oxidation inhibitor may be any compound that does not extensively affect the properties of the cured product, and examples thereof include hindered amine compounds such as bis(2,2,6,6-tetramethyl-4-piperidyl) sebacate and bis(1,2,2,6,6-pentamethyl-4-piperidyl)[[3,5-bis(1,1-dimethylethyl)-4-hydroxyphenyl]methyl]butylmalonate.

The total concentration of the chain transfer agent and the curing aid in the composition X can be in the range of 0.01 mass % or more and 10.00 mass % or less. Examples of the chain transfer agent and the curing aid include β-mercaptopropionic acid, 2-ethylhexyl-3-mercaptopropionate, n-octyl-3-mercaptopropionate, methoxybutyl-3-mercaptopropionate, stearyl-3-mercaptopropionate, 1-butanethiol, cyclohexanethiol, cyclohexyl 3-mercaptopropionate, 1-decanethiol, 2,4-diphenyl-4-methyl-1-pentene, 1-dodecanethiol, dodecyl 3-mercaptopropionate, 2-ethylhexyl mercaptoacetate, 2-ethylhexyl 3-mercaptopropionate, ethyl mercaptoacetate, 1-hexadecanethiol, hexyl 3-mercaptopropionate, 2-mercaptoethanol, 3-mercapto-1,2-propanediol, mercaptoacetic acid, sodium 2-mercaptoethanesulfonate, 3-mercaptopropionic acid, methyl mercaptoate, mercaptosuccinic acid, methyl 3-mercaptopropionate, octadecyl 3-mercaptopropionate, octyl 3-mercaptopropionate, 1-octanethiol, 1-octadecanethiol, tridecyl 3-mercaptopropionate, thiophenol, polyfunctional thiols such as bis(2-mercaptoethyl) sulfide, 3,6-dioxa-1,8-octanedithiol, trimethylolpropane tris(3-mercaptopropionate), 1,4-butanediol bis(thioglycolate) pentaerythritol tetra(3-mercaptopropionate), 1,4-benzenethiol, 3,7-dithia-1,9-nonanol, DL-1,4-dimercapto-2,3-butanediol, 1,5-dimercaptonaphthalene, dithioerythritol, ethylene bisthioglycolate, pentaerythritol tetrakismercaptoacetate, tris-[(3-mercaptopropionyloxyethyl)-isocyanurate, tetraethylene glycol bis(3-mercaptopropionate), dipentaerythritol hexakis (3-mercaptopropionate), 3,3′-thiodipropionic acid, dithiodipropionic acid, and laurylthiopropionic acid (dodecylthiopropionic acid), and commercially available products such as TS-G, C3TS-G, TA-G, and LDAIC (produced by Shikoku Chemicals Corporation) and Karenz MTPE1, BD1, NR1, and TPMB (produced by Showa Denko K.K.).

### Method for Preparing Composition X

The method for preparing the composition X is not particularly limited, and the simplest method is to weigh all the materials and then stir the weighed materials. However, to address the risk of polymerization, a polymerization inhibitor may be added as appropriate. When it is difficult to homogeneously mix the materials merely by heating, all of the materials may be dissolved in a solvent such as acetone and the solvent may be distilled away to prepare the composition X. Furthermore, stirring may be carried out by using an ultrasonic homogenizer, a ball mill, a disk mill, a planetary centrifugal mixer (Awatori Rentaro (registered trademark) produced by THINKY CORPORATION and MAZERUSTAR (registered trademark) produced by KURABO INDUSTRIES LTD.), or a disperser in which three-dimensional motions and automatic forward-reverse rotations are combined (Mazemazeman (registered trademark) produced by Misugi Co., Ltd.). These stirring methods may be performed multiple times or in combination. During stirring, heating may be conducted.

### Method for Producing Article

In the composition X curing step, the shape of the cured product and the curing method are not particularly limited.

Examples of the curing method include a method that involves applying the composition X to a substrate and then irradiating the applied composition X with light, a method that involves pouring the composition X into a mold and then irradiating the poured composition X with light, and an optical three-dimensional building method (stereolithography) that involves stacking thin-film cured products layer by layer.

The method for applying the composition X to the substrate is not particularly limited. For example, a contact transfer type application apparatus such as a roll coater, a reverse coater, a bar coater, or a slit coater or a non-contact type application apparatus such as a spinner (rotating application apparatus) or a curtain flow coater may be used to apply the composition X to the substrate to a desired film thickness to form a coating film. When conducting stereolithography by using the composition X of the present disclosure, any of the stereolithographic methods and apparatuses known in the art can be used. For example, the method may involve repeating a step of forming a cured product layer by photocuring the composition X at a particular thickness. A representative example of the stereolithography is a method that involves repeating a step of supplying the composition X at a particular thickness and then curing the composition X at a particular thickness on the basis of slice data generated on the basis of a three-dimensional shape data of a production target (three-dimensional model).

Stereolithography is roughly categorized into a free surface method and a constrained surface method. In both the free surface method and the constrained surface method, the step of forming a layer of the composition X involves placing a layer of the composition X between a stage in the liquid composition X and the liquid surface of the composition X. In the step of curing the composition X, the composition is irradiated with light through the liquid surface of the composition X. A layer of the composition X can be referred to as a composition layer. A cured layer of the composition X can be referred to as a cured product layer. The cured product Y obtained by the additive manufacturing method is a layered object in which multiple cured product layers are stacked. The thickness of one composition layer or cured product layer can be, for example, 1 μm or more and 10 μm or more and can be, for example, 1 mm or less and 100 μm or less, and the composition X is suitable for the composition layers of such a thickness. When an extremely thick composition layer is used, it may take a longer irradiation time or a higher irradiation intensity for the necessary curing.

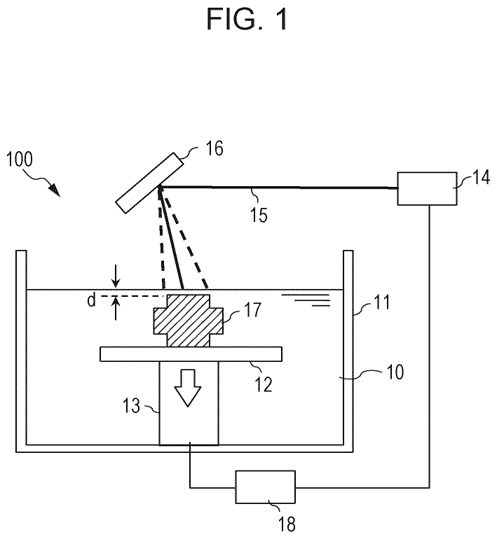

FIG. 1 illustrates an example structure of an additive manufacturing apparatus 100 that adopts a free surface method. The additive manufacturing apparatus 100 includes a vat 11 that comprises a feedstock liquid 10 composed of a liquid composition X. A stage 12 for building is disposed inside the vat 11 and is capable of being driven in a perpendicular direction by a drive shaft 13. An activation energy beam 15 for curing the feedstock liquid 10 and emerging from a light source 14 has its irradiation position altered by a galvanomirror 16 to scan the surface of the vat 11. In FIG. 1, the scan range is indicated by bold broken lines. The galvanomirror 16 is controlled by a controller 18 according to the slice data.

The thickness d of the layer (composition layer) of the feedstock liquid 10 composed of the composition X to be cured by the activation energy beam 15 is the value determined on the basis of the setting during generation of the slice data, and affects the accuracy of the article to be obtained (reproducibility of the three-dimensional shape data of an article to be built). The thickness d is achieved by the controller 18 controlling the drive amount of the drive shaft 13.

First, the controller 18 controls the drive shaft 13 on the basis of settings, and a feedstock liquid 10 composed of composition X and having a thickness d is supplied onto the stage 12. The liquid composition X on the stage 12 is irradiated with the activation energy beam 15 on the basis of the slice data such that a cured product layer of a desired pattern is obtained, as a result of which a cured product layer is formed. Next, the stage 12 is moved in the direction of the blank arrow, and the uncured composition X having a thickness d is supplied onto the surface of the cured product layer. Then the activation energy beam 15 is emitted on the basis of the slice data, and a cured product integrated with the previously formed cured product layer is formed as a result. By repeating this step of curing layer-by-layer, a layered object 17, which is an intended three-dimensional built object, can be obtained.

When a cured product layer of a particular geometric pattern is formed by irradiating the liquid surface of the composition X with the activation energy beam, a light energy ray focused into a dot or a line is used so that the resin can be cured in dots or lines. Alternatively, the resin may be cured by area irradiation with the activation energy beam through an area lithography mask formed by an array of multiple micro light shutters, such as liquid crystal shutters or digital micromirror shutters.

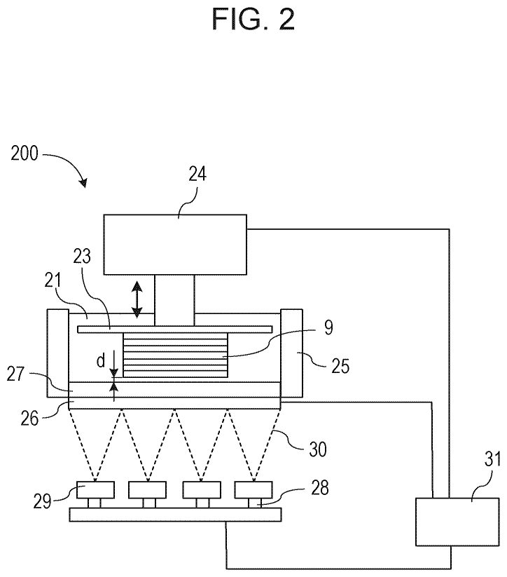

An object can be build by a constrained surface method as well as the free surface method. FIG. 2 illustrates an example structure of an additive manufacturing apparatus 200 that adopts a constrained surface method. The additive manufacturing apparatus 200 that adopts a constrained surface method illustrated in FIG. 2 has a structure in which a stage 23 of the additive manufacturing apparatus 200 illustrated in FIG. 2 is arranged to pull up a built object 9 upward with respect to the liquid surface, and a light irradiation unit is disposed below a vat 25. The additive manufacturing apparatus 200 includes a vat 25 that comprises a feedstock liquid 21 composed of a liquid composition X. A build stage 23 is disposed inside the vat 25 and can be moved up and down in a perpendicular direction by a lift device 24 and a controller 31. An activation energy beam 30 for curing the feedstock liquid 21 composed of the composition X is emitted from a light source 28 by the controller 31, and is magnified by a lens unit 29. Subsequently, a liquid crystal shutter 26 controlled by the controller 31 according to build data controls the irradiation region. The activation energy beam 30 that has passed through the liquid crystal shutter 26 passes through a releasing transmission film 27 and cures the feedstock liquid 21 composed of the composition X.

The thickness d of the layer (composition layer) of the feedstock liquid 21 composed of the composition X to be cured by the activation energy beam 30 is the value determined on the basis of the setting during generation of the build data, and affects the accuracy of the article to be obtained (reproducibility of the three-dimensional shape data of an article to be built). The thickness d is achieved by the controller 31 controlling the amount of upward and downward movement of the build stage 23 by the lift device 24 Here, unevenness that repeats at a particular pitch according to the thickness d is formed on a surface of the layered object 9 in a direction perpendicular to the moving direction of the build stage 23.

First, the controller 31 controls the lift device 24 on the basis of setting so that the build surface of the build stage 23 is a particular distance apart from the releasing transmission film 27, and a layer of a feedstock liquid composed of the composition X is supplied between the build surface of the build stage 23 and the releasing transmission film 27. Next, the activation energy beam 30 is emitted from under the vat 25 comprising the feedstock liquid 21 composed of the composition X. By irradiation with the activation energy beam 30, the feedstock liquid 21 composed of the composition X between the build surface of the build stage 23 and the releasing transmission film 27 becomes cured, and thus a solid cured product layer is formed.

After a predetermined dosage of the activation energy beam 30 is emitted and the feedstock liquid 21 composed of the composition X is cured, the build stage 23 is moved upward to separate the cured product layer from the releasing transmission film 27.

Next, the height of the build stage 23 is adjusted so that the cured product layer formed under the build stage 23 is a predetermined distance apart from the releasing transmission film 27. Then, as has been previously performed, a layer of the feedstock liquid 21 composed of the composition X is supplied between the cured product layer and the releasing transmission film 27, and a new cured product layer is formed between the previous cured product layer and the releasing transmission film 27 by irradiation with the activation energy beam 30 according to the build data. This step is repeated multiple times to obtain a layered object 9 in which multiple cured product layers are integrally stacked.

Here, the light source may be an LED light, a laser light source, or a projector, for example. When a laser light source is used, the dosage and the illumination level per unit area are controlled by the scanning rate, and there is no need to provide a liquid crystal shutter 26. Furthermore, a digital micromirror shutter may be used in addition to or instead of the liquid crystal shutter 26.

The layered object 17 and the layered object 9 obtained as such are respectively discharged from the vat 11 and the vat 25, the unreacted composition X remaining on the surfaces are removed, and then a post process is performed as necessary to obtain target articles.

Examples of the post process include washing, post curing, machining, polishing, and assembly. The detergent used in washing can be an alcohol organic solvent such as alcohols, for example, isopropyl alcohol and ethyl alcohol. Other examples of the detergent that can be used include ketone organic solvents such as acetone, ethyl acetate, and methyl ethyl ketone, and aliphatic organic solvents such as terpenes.

After washing, either or both of light irradiation and heat irradiation may be performed as necessary to conduct post curing. Post curing can cure the unreacted composition X that may remain on the surface or inside the built object, stickiness on the surface of the three-dimensional built object can be reduced, and the initial strength of the three-dimensional built object can be improved.

Examples of the activation energy beam include ultraviolet rays, electron beams, X-rays, radiations, and high frequencies. Among these, ultraviolet rays having a wavelength of 300 nm to 450 nm are highly versatile, and examples of the light source thereof include ultraviolet lasers (for example, diode pumped solid-state lasers, Ar lasers, and He—Cd lasers), high-pressure mercury lamps, ultrahigh-pressure mercury lamps, mercury lamps, xenon lamps, halogen lamps, metal halide lamps, ultraviolet LEDs (light-emitting diodes), and fluorescent lamps. Among these, ultraviolet lasers have excellent light-condensing properties, can increase the energy level and shorten the building time, and can achieve high building accuracy.

The method for evaluating the curability of the composition X will now be specifically described.

A silicone rubber sheet having an opening is tightly attached to a glass substrate, and the composition X is poured into the opening while preventing entry of air bubbles. A 405 nm UV light source is fixed at a position a predetermined distance apart from the surface of the substrate in a perpendicular direction such that the center of the light source aligns with the center of the irradiation surface. After UV irradiation, a stepped cured sample locally having portions with different curing thickness under different irradiation energy is prepared by masking the substrate with a UV shielding film. The irradiation energy can be calculated as a product of the irradiation intensity and the irradiation time.

After the irradiation, the uncured portions of the composition X are wiped off with an ethanol-saturated gauze, and the thickness of the cured composition X is measured at 1 μm accuracy with a thickness meter. The film thickness is determined as an average of the values measured on two specimens.

The thickness of the composition X is proportional to the logarithm of the irradiation energy. Thus, data is plotted on a horizontal axis indicating the values of the irradiation energy converted to the logarithmic axis and a vertical axis indicating the thickness of the composition X to calculate a logarithmic approximation formula. From the obtained logarithmic approximation formula, the irradiation energy necessary for forming a thickness of 50 μm is calculated, and the necessary irradiation time is calculated for an irradiation intensity of 3 mW/cm². A composition X with a short necessary irradiation time is evaluated as a composition X having excellent curability.

### Measuring the Amount of VOCs

In the present disclosure, the VOCs generated from the stereolithographically built object are organic compounds detected in the range of from n-hexane to n-hexadecane in gas chromatography with non-polar columns in conformity with JIS C 9913:2008. The method for measuring the amount of such VOCs generated is as follows.

A built object having 3 mm×4 mm×10 mm dimensions is prepared by the aforementioned building method, and is subjected to washing and secondary curing to prepare a specimen for VOC measurement. The mass of this specimen is measured with an electronic balance or an ultramicro balance.

The amount of the VOCs generated from the specimen is evaluated according to JIS C 9913:2008.

Specific descriptions are as follows.

A micro chamber is used as a VOC sampling device, and a sampling tube is connected to the micro chamber. The sampled specimen is then placed in a chamber inside the micro chamber retained at 85° C. to 95° C. The number of specimens placed here is 1. Next, N2 gas is fed to the chamber of the micro chamber at a flow rate of 100 mL/minute for 11 minutes to sample the VOCs generated from the specimen into the sampling tube.

Next, the sampling tube is placed in a thermal desorption apparatus and heated to 280° C. to desorb the VOCs in the sampling tube. The desorbed VOCs are introduced into GC-MS connected to the thermal desorption apparatus to measure the VOC components.

Toluene is used as the calibration substance, and chloroform is used as a solvent to prepare a toluene solution.

Next, the toluene solution is injected into the sampling tube under an N2 gas stream by using a micro syringe and a flow controller for a calibration curve preparation tool to sample toluene. Note that the solvent is not limited to chloroform as long as toluene to be measured is not affected.

Toluene D8 is used as the inner standard substance. Note that the inner standard substance is not limited to toluene D8 as long as the VOCs to be measured are not affected. The internal standard substance may be added by using an automatic addition function of the thermal desorption apparatus or may be added to the chamber of the micro chamber simultaneously with the specimen to be measured. In order to obtain an internal standard with excellent accuracy, addition by the automatic addition function of the thermal desorption apparatus can be employed.

The calibration curve is determined as follows. Peak areas of toluene and toluene D8 are obtained from the results of total ion chromatogram (TIC) of toluene added in a particular amount. Next, the peak area of toluene is divided by the peak area of toluene D8 to determine the value of the toluene/toluene D8 area ratio. Then a regression line is drawn from the relationship between the amount of toluene added and the area ratio and is assumed to be the calibration curve.

The amount of VOCs generated from the specimen is determined as follows. From the TIC results of a particular specimen, the peak area of a relevant component is obtained. Next, the peak area of this component is divided by the peak area of toluene D8 to determine the value of the area ratio.

When the relevant component is toluene, the value of the area ratio is substituted into the aforementioned calibration curve to obtain the amount of toluene (ng). The amount of toluene is divided by the unit mass of the specimen to determine the VOC amount ng/g of toluene.

When the relevant component is not toluene, the following procedure is implemented.

The peak area of the relevant component is divided by the peak area of toluene D8 to determine the value of the relevant component/toluene D8 area ratio. Then the calibration curve determined from the relationship between the amount of toluene and the toluene/toluene D8 area ratio is assumed to be the same as the calibration curve determined from the relationship between the amount of the relevant component and the value of the relevant component/toluene D8 area ratio.

Then the value of the relevant component/toluene D8 area ratio is substituted into the aforementioned calibration curve to obtain the toluene-equivalent amount (ng). This toluene-equivalent amount is divided by the unit mass of the specimen to determine the VOC amount ng/g of the relevant component.

The VOC components generated from the photopolymerization initiator are defined as decomposition products derived from the initiator generated after irradiation for the component that has not been generated before irradiation of the photopolymerization initiator with the activation energy beam.

### Applications

The composition X of the present disclosure can be used in three-dimensional additive manufacturing method, in particular, stereolithography.

Furthermore, a stereolithographically built object obtained by a 3D printer can be widely used in the optical three-dimensional building field. The application field is not particularly limited, and representative examples thereof include industrial products such as electric and electronic equipment, OA appliances, cameras, and computers. Other examples include prototype models, design models, working models, base models for preparing molds, direct molds for prototype molds, service parts, casings, and parts of industrial products. In particular, a stereolithographically built object that uses the composition X has little strain, and the amount of generated VOCs derived from the photopolymerization initiator is small; thus, the stereolithographically built object can be used in producing casings and parts of industrial products.

A device equipped with an article Z produced from the composition X may also be equipped with at least one selected from a thermoplastic resin member, a thermosetting resin member, and a metal member in addition to the article Z. The article Z, a member composed of a thermoplastic resin, and a member composed of a thermosetting resin can be employed in various applications including exterior packages, wiring boards, joints, ducts, covers, mounts, cams, guides, gears, bottles, and cartridges. When there are multiple thermoplastic resin members, a thermoplastic resin that is used in at least some of such members can be a PC-ABS resin from the viewpoint of flame retardancy. The article Z can be used in a variety of usage such as adhesives and sealing materials. The metal member can be used in a variety of usage such as casings, rollers, and heat sinks. The device may be equipped with, in addition to the article Z, at least one of an electric part, an optical part, and a mechanical part. The electric part is, for example, a circuit substrate, an integrated circuit component, a sensor, a display, or a motor. The optical part is, for example, a light source, a lens, or a mirror. The mechanical part is, for example, a roller, a gear, or a reinforcing part. Various types of devices are configured by combining at least one of the aforementioned thermoplastic resin member, thermosetting resin member, metal member, electric part, optical part, and mechanical part. The device can be a printing device or an office appliance device such as an inkjet printer, a laser printer, a scanner, a copier, or a multifunction printer. The device can be a video device such as a camera, a display, or a projector. The device can be an optical device such as a replaceable lens and a binocular. The device can be a medical device such as an X-ray machine, a CT, an MRI, or an endoscope. The device may be an industrial device such as an exposure apparatus, a film deposition apparatus, or a robot. The device may be any of various moving devices and transport devices such as automobiles, airplanes, and ships. The article Z can be used as various members and parts of components of these devices. The article Z can replace the PC-ABS resins that have been used in the members and components required to exhibit flame retardancy and mechanical strength. In such a case, non-black particles comprising a flame retardant can be used as the component D of the composition X.

### EXAMPLES

Sample Nos. 1 to 10 of the composition X are indicated in Table 1. Sample Nos. 11 to 21 of the composition X are indicated in Table 2. Tables 1 and 2 show mass concentrations (unit: mass %) of the components A to D in the composition X. In addition, “component D/component C” indicates a factor by which the concentration of the component D in the composition X is greater than the concentration of the component C in the composition X. Here, Sample Nos. 1 to 21 of the composition X are considered to be free of components other than the components A to D.

TABLE 1

| | | Sample No. | | | | | | | | | |
|---|---|---|---|---|---|---|---|---|---|---|---|
| Component | | 1 | 2 | 3 | 4 | 5 | 6 | 7 | 8 | 9 | 10 |
| Component A | A-1 | 27.18 | 27.17 | 20.90 | 20.90 | 20.90 | 20.90 | 20.90 | 20.90 | 29.70 | 37.20 |
| | A-2 | 31.06 | 31.05 | 23.90 | 23.90 | 23.90 | 23.90 | 23.90 | 23.90 | 19.90 | 16.50 |
| | A-3 | 38.83 | 38.82 | 29.88 | 29.85 | 29.88 | 29.85 | 29.88 | 29.85 | 24.78 | 20.68 |
| Component B | | 2.91 | 2.91 | 2.20 | 2.20 | 2.20 | 2.20 | 2.20 | 2.20 | 2.50 | 2.50 |
| Component C | C-1 | 0.02 | 0.05 | 0.02 | 0.05 | 0.02 | 0.05 | 0.02 | 0.05 | 0.02 | 0.02 |
| | C-2 | | | | | | | | | | |
| Component D | D-1 | | | 23.10 | 23.10 | | | | | 23.10 | 23.10 |
| | D-2 | | | | | 23.10 | 23.10 | | | | |
| | D-3 | | | | | | | 23.10 | 23.10 | | |
| | D-4 | | | | | | | | | | |

| | | | | | | | | | | |
|---|---|---|---|---|---|---|---|---|---|---|
| Component D/ | 0 | 0 | 1155 | 462 | 1155 | 462 | 1155 | 462 | 1155 | 1155 |
| Component C | | | | | | | | | | |
| Curability | A | A | A | A | A | A | A | A | A | B |
| VOC | A | A | A | A | A | A | B | B | A | A |

TABLE 2

| | | Sample No. | | | | | | | | | | |
|---|---|---|---|---|---|---|---|---|---|---|---|---|
| Component | | 11 | 12 | 13 | 14 | 15 | 16 | 17 | 18 | 19 | 20 | 21 |
| Component A | A-1 | 20.90 | 20.90 | 20.20 | 20.20 | 20.20 | 20.20 | 20.60 | 18.60 | 19.90 | 27.18 | 20.90 |
| | A-2 | 23.90 | 23.90 | 23.10 | 23.10 | 23.10 | 23.10 | 23.60 | 21.40 | 22.90 | 31.07 | 23.90 |
| | A-3 | 29.88 | 29.88 | 28.90 | 28.90 | 28.90 | 28.90 | 29.50 | 27.00 | 28.90 | 38.84 | 29.90 |
| Component B | | 2.20 | 2.20 | 3.70 | 3.70 | 3.70 | 3.70 | 2.20 | 7.50 | 2.20 | 2.91 | 2.20 |
| Component C | C-1 | 0.02 | | 1.00 | | 1.00 | | | | | | |
| | C-2 | | 0.02 | | 1.00 | | 1.00 | 1.00 | 3.00 | 3.00 | | |
| Component D | D-1 | | 23.10 | 23.10 | 23.10 | | | 23.10 | 22.50 | 23.10 | | 23.10 |
| | D-2 | | | | | | | | | | | |
| | D-3 | | | | | | | | | | | |
| | D-4 | 23.10 | | | | 23.10 | 23.10 | | | | | |

| | | | | | | | | | | | |
|---|---|---|---|---|---|---|---|---|---|---|---|
| Component D/ | 1155 | 1155 | 23 | 23 | 23 | 23 | 23 | 8 | 8 | — | — |
| Component C | | | | | | | | | | | |
| Curability | A | A | C | C | C | C | D | D | E | A | A |
| VOC | C | D | A | C | D | D | C | C | B | E | E |

The components in these examples are as follows.
Component A: photopolymerizable compound
   A-1: cyclopolymerizable compound Methyl 2-(allyloxy) acrylate (trade name: FX-AO-MA, produced by NIPPON SHOKUBAI CO., LTD.)
   A-2: polyfunctional radical polymerizable compound
Polyfunctional urethane acrylate (trade name: UA-160™ produced by Shin Nakamura Chemical Co., Ltd.)
   A-3: polyfunctional radical polymerizable compound
      Tris(2-acryloxyethyl) isocyanurate (trade name: A9300S produced by Shin Nakamura Chemical Co., Ltd.)
   Component B: Photopolymerization initiator
   Bis(2,4,6-trimethylbenzoyl)phenylphosphine oxide (trade name: Omnirad 819 produced by IGM Resins)
Component C: black particles
   C-1: carbon black, pH: 3.5, particle size: 24 nm
(trade name: MA100 produced by Mitsubishi Chemical Corporation)
   C-2: carbon black, pH: 8, particle size: 24 nm
(trade name: #44 produced by Mitsubishi Chemical Corporation)
Component D: non-black particles
   D-1: ammonium polyphosphate, particle size: 8 μm
(trade name: Exolit AP 423 produced by Clariant AG)
   D-2: sodium polyborate, particle size: 1 to 10 μm
(trade name: Best Boron (particle size: 50 to 200 μm) produced by Soufa Inc., crushed)
   D-3: calcium carbonate, particle size: 10 to 20 μm
(trade name: calcium carbonate produced by Kishida Chemical Co., Ltd.)
   D-4: silica, particle size: 9.5 μm
(trade name: HS-207 produced by NIPPON STEEL Chemical & Material Co., Ltd.)

Three types of the component A and the component B were weighed with an electronic balance (model “GF-2002” produced by A&D Company, Limited) at blend amounts indicated in Tables 1 and 2, and the resulting mixture was stirred for 3 hours or longer under heating using a mix rotor (model “VMRC-5” produced by AS ONE Corporation). The resulting mixture, the component C, and the component D were weighed into a planetary centrifugal mixing container in blend amounts indicated in Tables 1 and 2 by using an electronic precision balance (trade name: “AX-200” produced by SHIMADZU CORPORATION) and mixed and stirred for 5 minutes at a 2000 rpm by using a planetary centrifugal mixer (model “ARV-310P” produced by THINKY CORPORATION) so as to obtain a resin composition X.

### Curing Time Measurement

For each of the prepared compositions X, the light source position is adjusted by using an ultraviolet irradiator (EX250 produced by HOYA CANDEO OPTRONICS CORPORATION), and the irradiation time is varied so that the irradiation energy (=irradiation intensity x irradiation time) is 7.05 mW/cm², 11.75 mW/cm², 18.8 mW/cm², 23.5 mW/cm², 28.2 mW/cm², 35.3 mW/cm², and 47 mW/cm². After the irradiation, the uncured portion of the composition X is wiped off with an ethanol-saturated gauze, and the thickness of the cured film is measured with a thickness meter (543-390B produced by Mitutoyo Corporation). Measurement was conducted on two specimens for each composition X, and the average was calculated. This measurement data is plotted on the horizontal axis indicating the values of the irradiation energy converted to the logarithmic axis and the vertical axis indicating the thickness of the composition X to calculate the logarithmic approximation formula. From the obtained logarithmic approximation formula, the irradiation energy necessary for forming a thickness of 50 μm is calculated, and the necessary irradiation time is calculated for an irradiation intensity of 3 mW/cm².

### Evaluation of Curability

On the basis of the relationship between the irradiation energy (=irradiation intensity x irradiation time) and the curing thickness, the time needed to form a thickness of 50 μm is determined, and this time is used as the indicator of the curability. The evaluation standard is described below, where the shorter the time, the better the curability.
A: Shorter than 3 seconds.
B: 3 seconds or longer but shorter than 5 seconds.
C: 5 seconds or longer but shorter than 10 seconds.
D: 10 seconds or longer but shorter than 16 seconds.
E: 16 seconds or longer.

### Method for Preparing Cured Product for VOC Measurement

The aforementioned compositions X were used to fabricate stereolithographically built objects with a 3D printer (trade name: “MQ4K” produced by SUMAOPAI). The irradiation time per layer with a thickness of 50 μm is set to 3 seconds for A-rated curability, 10 seconds for C-rated curability, 16 seconds for D-rated curability, and 35 seconds for E-rated curability, the layers are stacked in the width direction of the test pieces to prepare a cured product. The cured product is washed with an organic solvent and is subjected to a secondary curing process for 1 hour with a secondary curing apparatus (trade name: “Formcure” produced by Formlabs).

Furthermore, the resulting cured product is placed in a 100° C. heating oven and heat-treated for 1 hour to obtain a cured product for VOC measurement.

### Measuring the Amount of VOCs

A built object having 3 mm×4 mm×10 mm dimensions is prepared and is subjected to washing and secondary curing to prepare a specimen for VOC measurement. The mass of this specimen is measured with a precision balance.

A micro chamber (trade name: “M-CTE250” produced by Markes International Ltd.) was used as the VOC sampling device, and “Tenax TA” (trade name) produced by Markes International Ltd., was used as the sampling tube. The sampled specimen is then placed in a chamber inside the micro chamber retained at 90° C. The specimen for VOC measurement was the built object as was and no cutting or breaking was performed. N2 gas is fed to the chamber at a flow rate of 100 ml/minute for 11 minutes to sample the VOCs generated from the specimen into the sampling tube. In addition, the calibration substance is prepared by dissolving toluene in a chloroform solvent. Next, the toluene-comprising solution was injected into the sampling tube under an N2 gas stream by using a micro syringe and a flow controller for the calibration curve preparation tool to sample toluene.

Next, the sampling tube was placed in a thermal desorption apparatus (trade name: “Centri” produced by Markes International Ltd.) and heated to 280° C. to desorb the VOCs in the sampling tube. The desorbed VOCs are condensed in a −10° C. cold trap and then re-heated to 300° C. to be introduced into GC/MS (trade name: “JMS-Q1600GC” produced by JEOL Ltd.). Toluene D8 is used as the inner standard substance, and 0.15 ng is added by using the automated titration function of the thermal desorption apparatus. The GC oven was heated at a heating rate of 10° C./minute from 40° C. to 300° C. The carrier gas is pure He (purity of 99.9995% or higher), the column (trade name: “HP-5” produced by Agilent Technologies Inc.) used has a length of 30 m, an inner diameter of 320 μm, and a film thickness of 0.25 μm, and the GC-IF temperature is set to 270° C. EI is used as the MS ion source, the ionization current is set to 30 μA, the ionization energy is set to 70 eV, and the ionization temperature is set to 230° C. Next, the VOC components are measured within the range of m/z=50 to 600.

A calibration curve for detecting the amount of VOCs is drawn by using toluene and toluene D8 by the aforementioned method to obtain the VOC amount (ng/g).

The VOC components derived from the photopolymerization initiator, that is, bis(2,4,6-trimethylbenzoyl)-phenylphosphine oxide, added to the photopolymerizable composition X are, as a substance having a trimethyl structure, 1,3,5-trimethylbenzene, 2,4,6-trimethylbenzaldehyde, 2,4,6-trimethylbenzoic acid, and ethyl 2,4,6-trimethylbenzoate.

Evaluation of Amount of Generated VOCs Derived from Photopolymerization Initiator

The amount of VOCs derived from the decomposed components of the photopolymerization initiator generated from the surface of the stereolithographically built object was determined. The evaluation standard is described below, where the smaller the VOC amount, the better from the viewpoint of VOCs.
A: Less than 200 ng/g.
B: 200 ng/g or more and less than 500 ng/g.
C: 500 ng/g or more and less than 1000 ng/g.
D: 1000 ng/g or more and less than 2000 ng/g.
E: 2000 ng/g or more.

Tables 1 and 2 indicate that Nos. 1 to 19 comprising the component C generate less VOCs compared with Nos. 20 and 21 not comprising the component C. In addition, among Nos. 3 to 20 comprising the component D, Nos. 3 to 10 and 13 in which the component C-1 composed of carbon black having a pH of 4.0 or less is combined with the component D-1, D-2, or D-3 composed of salt-comprising non-black particles generate less VOCs compared with Nos. 12, 14, and 16 to 19 that use the component C-2 and Nos. 11, 15, and 16 that use the component D-4.

When non-black particles are comprised in the composition X, the particles scatter irradiation light, such as UV light, and a wider region is exposed to light and the amount of the VOC components derived from the photopolymerization initiator increases. Combining the salt-comprising non-black particles and the black particles having a pH of 4.0 or less generates a bias in the distribution of the black particles. Thus, compared with the case where the salt-comprising non-black particles are not comprised, the degree of degradation of the curability when black particles are increased is smaller. Moreover, degradation of the curability was observed as the concentration of the component C increased; however, in Nos. 1 to 12 where the amount of the component C is small, the amount of the VOCs generated is sufficiently decreased while sufficiently high curability can be achieved.

As described above, according to the composition X of the present disclosure, even when low-reactivity polymerizable compounds and non-black particles are comprised, a cured product Y can be obtained without excessively degrading the curability of the composition X while reducing the amount of the VOCs generated.

The present disclosure is not limited by the embodiments described above, and the embodiments can be subject to numerous modifications and alterations within the technical concept of the present disclosure. For example, among the multiple embodiments and modification examples described above, at least two may be used in combination. Furthermore, the effects described in the embodiments are merely the most desirable effects of the embodiments of the present disclosure, and the effects of the embodiments of the present disclosure are not limited to those described in the embodiments.

The contents of the disclosure of the present specification include not only those explicitly disclosed in the present specification but also all matters that are comprehensible from the present specification and the drawings attached to the present specification. The contents of the disclosure of the present specification include complementary sets of individual concepts described in the present specification. That is, for example, a phrase “A is B” in the specification is considered as that the present specification also discloses “A is not B” although the indication that the “A is not B” is omitted. This is because when there is a phrase “A is B”, the presumption is that the case in which “A is not B” is taken into account.

Regarding specific numerical ranges indicated as examples in the present specification, the notation “e to f” (where e and f each represent a number) means “e or more and/or f or less”. Furthermore, regarding any specific numerical range indicated as an example, if a range of i to j and a range of m to n (where i, j, m, and n each represent a number) are both described, the combination of the lower limit and the upper limit is not limited to the combination of i and j or the combination of m and n. For example, the lower limit and upper limit of multiple combinations can be combined. That is, when a range of i to j and a range of m to n are both described, a range of i to n may be studied and/or a range of m to j may be studied as long as no contradiction arises. Furthermore, “e or more” means e or larger than e (exceeding e), and a value larger than e may be employed instead of e. In addition, “f or less” means for smaller than f (less than f), and a value smaller than f may be employed instead of f.

The technology disclosed in the present specification can contribute to realizing a sustainable society such as a decarbonized, recycle-based society.

The present disclosure provides a technology that allows for a photocurable composition to advantageously achieve both the curability and the decrease in VOCs.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-071452, filed Apr. 25, 2024, which is hereby incorporated by reference herein in its entirety.

What is claimed is:

1. A photocurable composition comprising:
a first component composed of a photopolymerizable compound;
a second component composed of a photopolymerization initiator;
a third component composed of black particles; and
a fourth component composed of non-black particles,
wherein:
the fourth component comprises non-black particles having a particle size of 1 μm or more and 20 μm or less, and
a mass concentration of the fourth component in the composition is more than 200 times a mass concentration of the third component and less than 3000 times the mass concentration of the third component.

2. A photocurable composition comprising:
a first component composed of a photopolymerizable compound;
a second component composed of a photopolymerization initiator;
a third component composed of black particles; and
a fourth component composed of non-black particles,
wherein:
the first component comprises a cyclopolymerizable compound,
the third component comprises black particles having a pH of 4.0 or less or 9.0 or more, and
the fourth component comprises non-black particles comprising a salt.

3. A photocurable composition comprising:
a first component composed of a photopolymerizable compound;
a second component composed of a photopolymerization initiator; and
a third component composed of black particles,
wherein:
the first component comprises a cyclopolymerizable compound, and
a mass concentration of the third component in the composition is 0.01 mass % or more and less than 0.10 mass %.

4. The composition according to claim 3, further comprising a fourth component composed of non-black particles.

5. The composition according to claim 2, wherein:
the third component comprises black particles having a pH of 4.0 or less, and
the fourth component comprises non-black particles comprising a polyoxoacid salt.

6. The composition according to claim 2, wherein the fourth component comprises non-black particles comprising a flame retardant.

7. The composition according to claim 3, wherein a mass concentration of the second component in the composition is 1 mass % or more and 5 mass % or less.

8. The composition according to claim 1, wherein a mass concentration of the third component in the composition is 0.01 mass % or more and less than 0.10 mass %.

9. The composition according to claim 1, wherein a mass concentration of the fourth component in the composition is 10 mass % or more and 30 mass % or less.

10. The composition according to claim 2, wherein:
the third component comprises black particles having a first particle size,
the fourth component comprises non-black particles having a second particle size, and
the second particle size is 10 times the first particle size or more and 2000 times the first particle size or less.

11. The composition according to claim 1, wherein the first component comprises a cyclopolymerizable compound.

12. The composition according to claim 2, wherein the first component comprises monofunctional 2-(allyloxymethyl) acrylic acid or an ester thereof represented by general formula (1).

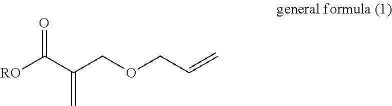

13. The composition according to claim 12, wherein, in general formula (1), R represents hydrogen or a hydrocarbon group having 1 or more and 4 or less carbon atoms.

14. The composition according to claim 3, wherein the second component comprises a compound intramolecularly having trimethylbenzene.

15. The composition according to claim 2, wherein the second component comprises an acylphosphine oxide compound.

16. The composition according to claim 2, wherein the third component comprises carbon black.

17. The composition according to claim 1, wherein the third component comprises black particles having a particle size of 10 nm or more and 1 μm or less.

18. The composition according to claim 1, wherein the fourth component comprises non-black particles having a particle size of 1 μm or more and 20 μm or less.

19. A method for producing an article, the method comprising:
a step of forming a layer of the composition according to claim 1; and
a step of curing the layer of the composition by irradiation with light,
wherein these steps are repeated to build a layered object.

20. A method for producing an article, the method comprising:
a step of forming a layer of the composition according to claim 2; and
a step of curing the layer of the composition by irradiation with light,
wherein these steps are repeated to build a layered object.

21. A method for producing an article, the method comprising:
a step of forming a layer of the composition according to claim 3; and
a step of curing the layer of the composition by irradiation with light,
wherein these steps are repeated to build a layered object.

22. The method according to claim 20, wherein
during the step of forming a layer, the layer of the composition is formed between a build stage disposed in a liquid of the composition and a liquid surface of the composition, and, in the step of curing, the composition is irradiated with light through the liquid surface.
